(19) United States
(12) Patent Application Publication
(10) Pub. No.: US 2023/0356836 A1
(43) Pub. Date: Nov. 9, 2023

(54) AERIAL VEHICLES

(71) Applicants: Michael VON BERTOUCH, Kardinya (AU); Adam KELLY, Kardinya (AU)

(72) Inventors: Michael VON BERTOUCH, Kardinya (AU); Adam KELLY, Kardinya (AU)

(21) Appl. No.: 18/316,963

(22) Filed: May 12, 2023

Related U.S. Application Data
(63) Continuation of application No. PCT/AU2021/051343, filed on Nov. 12, 2021.

(30) Foreign Application Priority Data
Nov. 13, 2020 (AU) 2020904185

(51) Int. Cl. B64C 29/00

(52) U.S. Cl. CPC B64C 29/0016

(57) ABSTRACT

An aerial vehicle has a fuselage, at least one wing, propulsion means for forward flight and at least two pairs of arms. Each arm supports at least one rotor powered for vertical take-off and landing (VTOL) and each arm is in a deployed position for vertical take-off or hovering and transitions to a retracted position for forward flight using the at least one wing, and the arms re-transition to a deployed position for vertical landing or hovering.

### CROSS-REFERENCE TO RELATED APPLICATIONS

This application is a continuation of International Application No. PCT/AU2021/051343, filed Nov. 12, 2021, which claims priority to Australian Patent Application No. 2020904185, filed 13 Nov. 2020, both of which are incorporated by reference herein in their entireties.

### TECHNICAL FIELD

The present invention relates to one or more features of an aerial vehicle.

The present invention finds application in relation to manned aerial vehicles (MAVs) or unmanned aerial vehicles (UAVs), such as remotely piloted or computer controlled/guided UAVs (a UAV can commonly be termed a ‘drone’). BACKGROUND

Hybrid vertical take-off and landing (VTOL) and fixed-wing aircraft are known. Such aircraft typically use the VTOL for flight when hovering, take-off and landing, and the fixed-wing during forward flight of the aircraft.

Advantageously, the hybrid VTOL and fixed-wing aircraft can be operated via remote control, on-board computer guidance or manned.

It is known to retract the VTOL propellers during forward flight to reduce drag for fuel efficiency and create an aerodynamic profile of the aircraft, providing for improved control, flight stability and more efficient flight. In addition, the retraction of the VTOL propellers will help to reduce radar signature of the aerial vehicle.

Redundancy in on-board systems can be important on a manned or unmanned aerial vehicle. Particularly for UAVs, redundancy in on-board systems can help to ensure sustained flight and at least a ‘return to home’ functionality in the event of one system failing.

It will be appreciated that one or more forms of the present invention advantageously provides a convenient arrangement for transitioning between VTOL and forward flight and/or streamlining and/or redundancy in aerial vehicle systems and/or operating a manned or unmanned aerial vehicle.

It is against this background and the problems and difficulties associated therewith that the present invention has been developed.

### SUMMARY

An aspect of the present invention provides an aerial vehicle, said vehicle having: a fuselage and at least one wing;
a propulsion means for forward flight of the aerial vehicle;
at least two pairs of arms, each said arm supporting at least one rotor, wherein each said rotor is powered for vertical take-off and landing (VTOL) of the aerial vehicle; and
wherein each said arm is retractable between a deployed position for vertical take-off or hovering and a retracted position during forward flight.

Each said arm can also be deployable between a retracted position during forward flight to a deployed position for hovering and/or vertical landing.

The at least one wing and the fuselage may provide a blended-wing structure. For example, the at least one wing and fuselage may provide a continuous structure. A blended wing body (BWB), also known as blended body or hybrid wing body (HWB), is a fixed-wing aircraft having no clear dividing line between the wings and the main body of the craft. The aircraft has distinct wing and body structures, which are smoothly blended together with no clear dividing line. A BWB structure may or may not be tailless.

The fuselage may include a recess for receiving a respective arm when retracted.

At least one door may be provided to cover the respective arm when received within the recess.

Arms on a first side of the aerial vehicle may be retracted into a first said recess, and the arms on a second side of the vehicle may be retracted into a second said recess.

The aerial vehicle may include a front left arm, a front right arm, a rear left arm and a rear right arm.

The front left arm and rear left arm may retract into a first said recess (e.g. on the left side of the aerial vehicle). The front right arm and rear right arm may retract into a second said recess (e.g. on the right side of the aerial vehicle).

The arms may form a front pair and a rear pair, where the front pair is formed by the left and right front arms, and the rear pair is formed by the left and right rear arms.

Each pair of arms (front pair or rear pair), may move at a different rate and different rotational rate to the other pair of arms when extending or retracting.

The rotors at the ends of each arm align to a longitudinal axis of the aerial vehicle during at least part of the retraction and/or deployment of the arms.

The alignment of the rotors is preferably via sensing, such by use of at least one position sensor e.g. at least one rotary sensor for detecting rotational position of the respective rotor and/or an associated motor and/or associated drive belt.

For example, the rotors are stopped when at least one sensor senses the long axis of the rotors are substantially parallel to the longitudinal axis (e.g. for retraction and/or deployment).

The front and rear pairs of arms may move in synchronisation when extending or retracting the arms, so that each arm pair moves through identical symmetric ranges of motion at substantially the same velocity.

The front and rear pairs of arms within each pair, may move during extension and retraction through identical symmetric ranges of motion at substantially the same velocity.

The propulsion means may include at least two power units, such as a first and a second power unit. Each of the power units may be the same as the other of the power units.

Alternatively, the power units may differ in capability from each other. For example, the first power unit may include an engine operating at high efficiency whilst the second power unit may be an engine which is stopped.

The power units may be at least one of a rotary internal combustion engine, a gas turbine engine or an electric engine. For example, the first power unit may be a rotary internal combustion engine, whilst the second power unit may be an electric engine or turbine or fan engine.

The propulsion means may include at least one fan powered by the at least two power units.

Air speed (preferably forward air speed) and/or power unit (rpm) speed may be used to provide a signal to open each door and stow each pair of arms into each recess/opening.

Air speed and/or power unit (rpm) speed may be used to provide a signal to open each said door and extend each pair of arms from each opening.

The signal may be provided by a position sensor indicating position of one or more of the electric motors, the arms and/or the rotors, such as relative to each other and/or to the fuselage and/or wing(s).

The position sensor may be a combination of a dipole magnet and a hall effect position sensor.

The position sensor may provide position information to an electronic speed controller.

A controller receives rotor position information to maintain relative position of the rotors during retraction or deployment of the arm(s) to ensure that the rotors are aligned as required.

The electric motors may be located via holes, to each arm.

The holes are slotted allowing the position of the electric motors to be adjusted, and the driving belt tension to be adjusted.

The electric motors may be attached to a mounting plate which may be attached to at least one of the arms.

The mounting plate may have holes to allow the position and tension of the driving belt to be adjusted.

The at least one rotor may be two rotors contra-rotating to each other.

The at least one door may be opened and closed in correlation to the movement of the respective arms.

The at least one door may be two doors, which open and allow the respective arms to extend in a coordinated manner for take-off and landing.

The two doors may be closed, when stowing the respective arms during forward flight.

The arms may hinge to respective points inside the recess.

The hinge may have an upper attachment bracket and a lower attachment bracket.

The upper attachment bracket and the lower attachment bracket may attach to the arms by a retained bearing and a fastener.

The upper attachment bracket and the lower attachment bracket may be attached to the respective recess within the fuselage using a fastener or adhesive.

The fuselage end of the arms may be bifurcated to provide space for at least two motors to be installed and respective driving belts adjusted.

The bifurcated end of the arms may have a removable strut to improve structural rigidity of the arms.

The movement of the arms may be performed by a drive lug rigidly attached to each arm at a predetermined location, wherein a pushrod is connected to the drive lug enabling the pushrod to rotate relative to the drive lug.

The opposite end of the push rod may connect to an idler arm, wherein the connection is such that the pushrod rotates relative to the idler arm, wherein the other end of the idler arm connects to an attachment bracket to constrain the movement about a substantially vertical pivot axis.

The arms may have an attachment bracket, wherein the attachment bracket may attach to the interior of the recess within the fuselage by a fastener or adhesive.

The idler arm may be attached to a linear actuator, wherein the linear actuator rotates relative to the idler arm and the attachment bracket.

The linear actuator may be attached to the respective opening within the fuselage by a fastener or adhesive, allowing the extension or retraction of the respective arm.

The linear actuator may be powered by an electric motor, or hydraulic pressure or pneumatic pressure.

The linear actuator may have an integrated position sensor, wherein the integrated position sensor provides an instantaneous position of a rod of the linear actuator.

The at least one door may be attached to the fuselage by at least two hinges, wherein at least one hinge may be an actuator hinge.

The actuator hinge may have a fuselage attachment lug and a door actuation lug; wherein the fuselage attachment lug is fastened or bonded to the fuselage; wherein the door actuation lug is fastened or bonded to the respective door; wherein the fuselage attachment lug and the door actuation lug are attached by a pin for rotation wherein at least one of the at least two hinges may be a non-actuator hinge.

The door actuation lug may have an attachment point for a second linear actuator, to rotate relative to the door actuation lug.

The second linear actuator may be attached to a mounting bracket using a pin for rotation relative to the mounting bracket, wherein the mounting bracket is attached to the internal portion of the opening within the fuselage by a fastener.

An aspect of the present invention provides an aerial vehicle, having:

a propulsion means including at least two engines, the at least two engines arranged and configured to power at least one propulsion means.

The at least two engines power the at least one propulsion means, such as at least one propeller, fan or ducted fan, for forward flight of the aerial vehicle.

The propulsion means may include at least one ducted fan, fan or propeller powered by the at least two engines via at least one belt. The at least one belt may be a single drive belt or multiple belts.

The at least one belt may be a serpentine belt.

The at least two engines may each be operatively coupled to at least one clutch. Each said engine may be operatively coupled to a respective clutch.

The at least one clutch allows the at least two engines to have one engine on (driving) whilst the other engine is off and the respective clutch freewheeling.

The at least one clutch connects to at least two drive pulleys, wherein the at least one clutch allows one of the at least two drive pulleys to freewheel when one of the at least two engines is off.

The clutch may operate the at least two engines at differing power values.

The at least one clutch may include a roller (or Sprag) type clutch.

Sensed forward air speed or change in forward air speed of the aerial vehicle may be used to provide a signal to:
Open at least one door on the fuselage of the aerial vehicle and/or to extend a pair of stowed arms; and/or
To retract and stow the pair of arms and close the doors.

The propulsion means may be mounted on the fuselage in an airstream.

The propulsion means may be stowed away during take-off and landing for a greater aerodynamic profile.

The propulsion means may be supported by a support arrangement, such as a strut assembly, for mounting the propulsion means to the fuselage.

The support arrangement, such as the strut assembly, may have at least two struts and be preferably arranged in an inverted V configuration.

The propulsion means is preferably located above the at least two engines.

The at least two struts may comprise a fixed structural component and a removable fairing. The removable fairing is preferably aerodynamic, particularly with respect to forward direction of the aerial vehicle.

The fixed structural component is preferably rigid for attachment of the at least two engines.

The at least one common drive belt may be located in use between the fixed structural component and the removable fairing.

The removable fairing may be removed to allow the at least one common drive belt to be replaced or serviced.

An idler pulley is preferably used to tension the at least one common drive belt. Preferably, the at least two engines are covered by a fairing wherein the fairing is preferably air flow smoothed to provide an aerodynamic flow path for air near the propeller/fan.

At least one battery is included onboard the aerial vehicle to power the vehicle during VTOL. For example, during forward flight the aerial vehicle is not in VTOL mode and the at least one battery is in recharge mode recharging ready for when placed in VTOL mode.

When recharging the battery, the battery preferably recharges during forward flight. Recharging may replace battery charge used during take-off/hovering prior to full forward flight.

Recharging may preferably be provided up to the maximum time capability required for full charge or at least sufficient for landing the aerial vehicle. For example, the maximum battery charge delivery time capability may be 2-10 minutes at full power delivery.

A method of operating an aerial vehicle, said method comprising,
during forward flight of the aerial vehicle:
a) transitioning the aerial vehicle to a forward flight mode by retracting vertical lift rotor arms for full forward flight, or
b) transitioning the aerial vehicle to a vertical landing mode by extending the vertical lift rotor arms.

A method of operating an aerial vehicle, includes transitioning arms supporting lift rotors from an extended position to a retracted position, or between a retracted position and a deployed position, during forward flight of the aerial vehicle.

A method of operating an aerial vehicle may include:
a) extending arms supporting lift rotors for vertical take-off;
b) ascending the aerial vehicle and generating forward flight; and
c) retracting the arms and rotors.

A method of operating an aerial vehicle may include:
a) during forward flight, extending arms supporting lift rotors to an extended position;
b) reducing forward flight propulsion and increasing lift from the lift rotors;
c) descending the aerial vehicle to a landing position with the arms extended and the lift rotors providing descent power.

Each said rotor arm may support at least one rotor.

The at least one rotor may be ceased rotating prior to retraction and stowage. The at least one rotor may be commenced rotating once the respective arm is at least partially retracted.

Preferably each said arm supports at least two said rotors thereon. Each said rotor acts as bladed substantially horizontal rotor for vertical lift and/or hovering.

Each said rotor may be powered for rotation by a respective motor, such as an electric motor. Thus, two rotors supported by an arm may each be driven by a respective motor.

The retraction and extension of the arms is powered preferably by pneumatic, hydraulic or electrical means.

Retraction of the respective arm or arms can include pivoting retraction and/or elongate retraction. Likewise, extension (deployment) can include pivoting deployment and/or elongate extension.

Rotor position sensing may be provided. For example, for retraction and/or stowage of the respective rotor(s) and/or arm(s), a rotational position of the respective rotor can be sensed, and a desired rotational position maintained during retraction and/or deployment of the respective arm(s).

Position sensing of the respective rotor can be by a sensor (such as a rotary encoder, Hall effect sensor, optical sensor, magnetic sensor, or a combination of two or more thereof).

Position sensing can be provided for each motor, such as by sensing rotor or stator position of the motor with respect to a reference.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### BRIEF DESCRIPTION OF THE DRAWINGS

One or more embodiments of the present invention will hereinafter be described with reference to the accompanying Figures, in which:

FIG. 1 shows a schematic view of a front profile of an embodiment of the invention.

FIG. 2 shows a schematic view of an underneath profile of the embodiment of FIG. 1 of the invention.

FIG. 3 shows a schematic view of a front profile of another embodiment of the invention.

FIG. 4 shows a schematic view of an underneath profile of the embodiment of FIG. 3 of the invention.

FIG. 5 shows a schematic side section view of one arm of the embodiment of FIG. 1.

FIG. 6 is an enlarged side section view of the electric motors in FIG. 5.

FIG. 7 is a schematic view of FIG. 6 illustrating the setup of the electric motors.

FIG. 8 is a schematic side section of the embodiment of FIG. 5.

FIG. 9 is a schematic angled side view of the embodiment of FIG. 5.

FIG. 10 is a schematic view of the rotors and associated assembly of an embodiment of FIG. 1.

FIG. 11 is a schematic view of the door of an embodiment of FIG. 1.

FIG. 12 is a side schematic view of the door operating mechanism of the embodiment of FIG. 11.

FIG. 13 is an exploded schematic of the fan operating mechanism of an embodiment of the invention.

FIG. 14 is a partially exploded schematic of a side section of the fan operating mechanism.

FIG. 14A is an underneath view of the fan operating mechanism.

FIG. 14B is a side view of the fan operating mechanism.

FIG. 14C is a side section through the centre line of FIG. 14B.

FIG. 14D is a front view of the fan operating mechanism of FIG. 14.

FIG. 14E is a partially exploded schematic of a side section of the fan operating mechanism according to an embodiment of the present invention.

FIG. 14F is an underneath view of the fan operating mechanism of FIG. 14E.

FIG. 14G is a side view of the fan operating mechanism of FIG. 14E.

FIG. 14H is a side section through the centre line of FIG. 14G.

FIG. 14I is a front view of the fan operating mechanism of FIG. 14E.

FIG. 15 is a flow diagram illustrating an embodiment of the invention in operation.

FIG. 16 is a bottom view of the retraction of the forward arms in an embodiment of the invention.

FIG. 17 is a bottom view of the retraction of the rear arms in the embodiment of FIG. 16.

FIG. 18 is a flow diagram illustrating another embodiment of the invention in operation.

FIG. 19 is an exploded view of the embodiment of FIG. 7, illustrating the position sensor positioning.

FIG. 20 is a control flow diagram illustrating the control aspects of the system.

### DETAILED DESCRIPTION

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

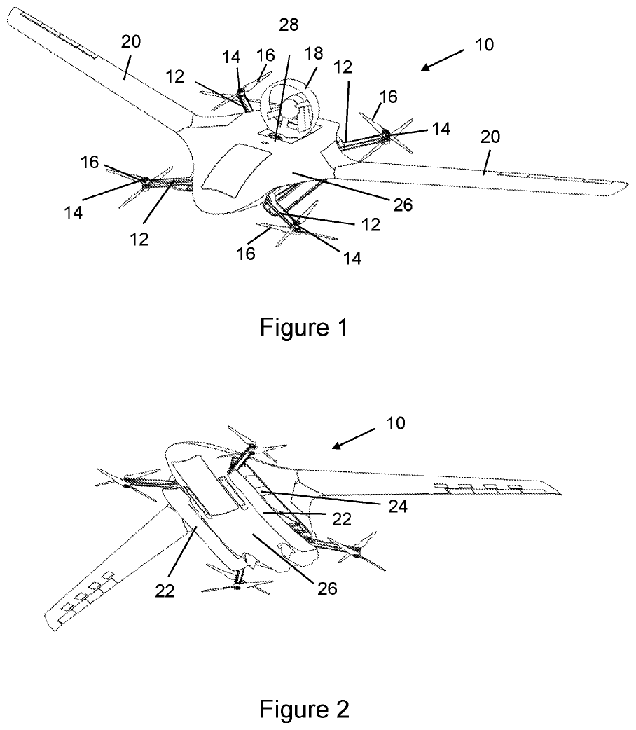

FIG. 1 shows an aerial vehicle 10 in either hover mode in the air or stationary mode on the ground. There are four arms 12, towards an inboard end the end of each arm 12 there is at least one electric motor 14. The electric motors 14 in turn power at least one rotor 16, which may be a dual coaxial contra-rotating rotor arrangement or a single rotor. The embodiment shown is the former type of rotor 16.

A fan 18 propels the aerial vehicle 10 in a forward flight mode. The fixed wings 20 provide lift once in forward flight mode.

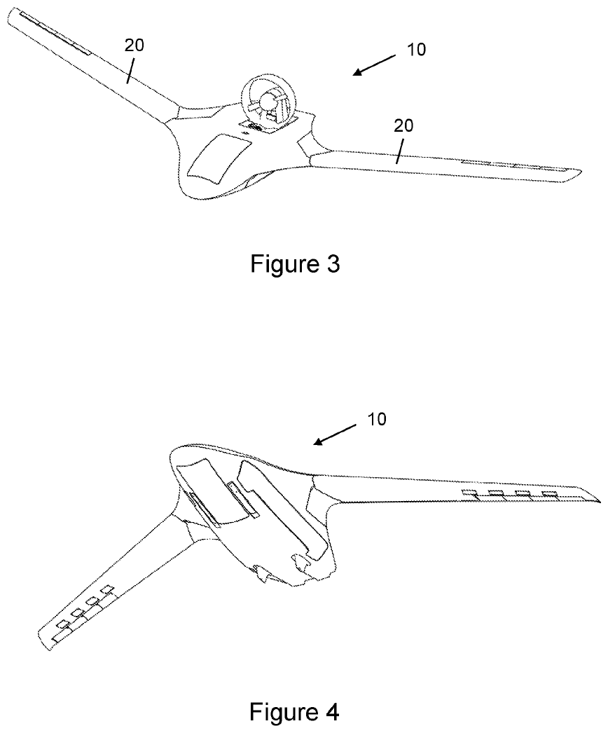

FIG. 2 shows the underside of FIG. 1. The doors 22 cover the openings 24 within the fuselage 26. The doors 22 can be open during grounding of the aerial vehicle 10 and/or during hover flight.

The electric motors 14 operate the rotors, such as via drive belts, to create vertical lift (VTOL mode).

When a minimum forward airspeed is reached, the aerial vehicle 10 signals the arms 12 to retract and the aerial vehicle uses only the fixed wings 20 for powered flight.

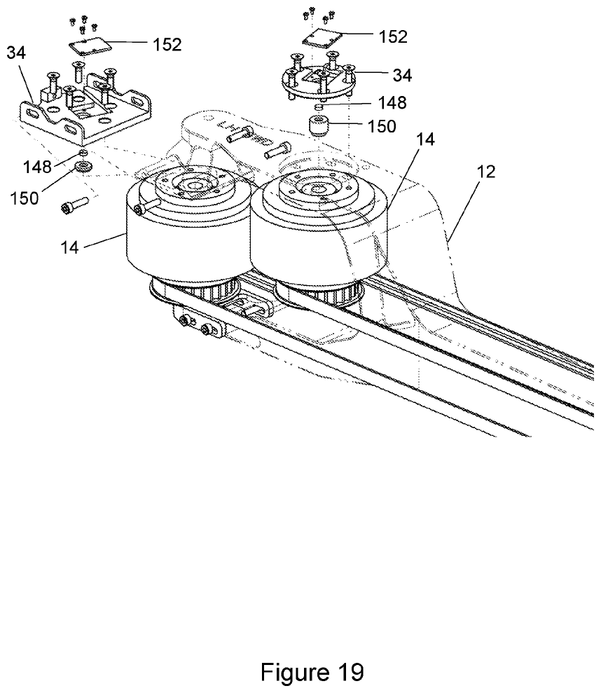

Referring to FIG. 19, the signal is provided by preferably a position sensor that indicates the rotational position of the electric motors 14 and/or the respective rotors 16.

Such positioning sensing is preferably provided using a dipole magnet 148 bonded to a magnet mount 150 which is preferably attached coaxially to the respective electric motors shaft (not shown) and a hall effect position sensor 152 coaxially attached to the fixed mounting plate 34 with the dipole magnet 148.

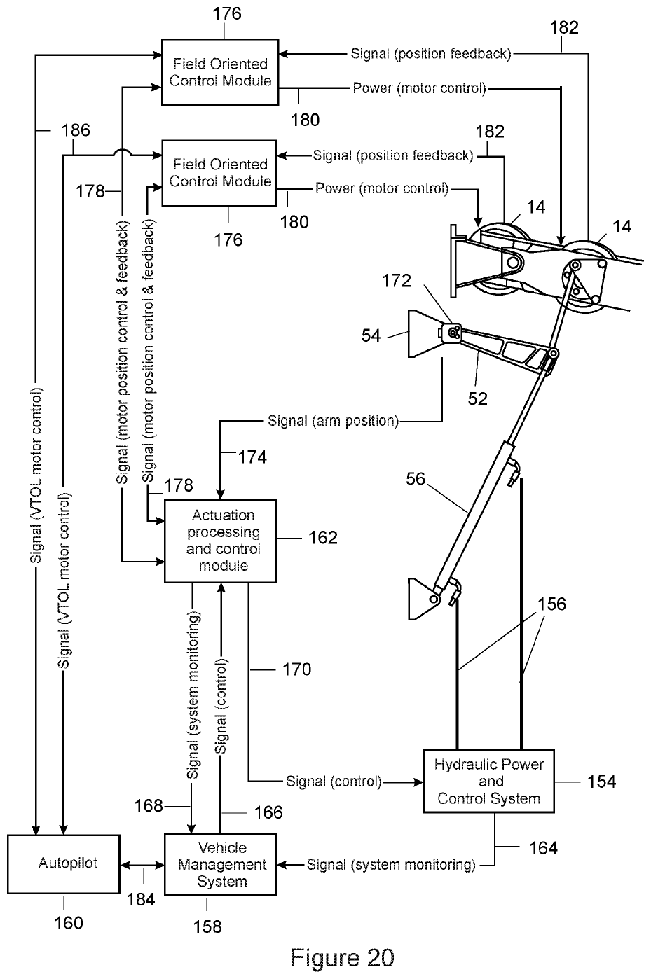

Referring to the flow chart of FIG. 20, position feedback information is provided from the sensors to the electronic speed controller (not shown). Extension and retraction of the arms 12 is preferably performed by a hydraulic power supply and control system 154 that is connected to the linear actuator 56 via flexible hydraulic hoses 156.

The propulsion forward is supplied by the fan 18 and at least one of its engines 28. An oil tank 200 provides a reservoir for a supply of oil for engine 28 lubrication. Air inlet/s 112 are air intakes for the engine 128 and the engine bay. The air from air inlet/s 112 feeds air to air boxes 210 which have air filters within (not shown). The air inlet/s 112 also feed air to the pipes 220, which provide a fresh air feed to the engine bay.

The vehicle management system 158 provides control functions for the aerial vehicle 10 including directing the autopilot 160; directing the actuation processing and control module 162 as required, in order to coordinate the VTOL functions provided by the autopilot 160; and directing the arms 12 retraction/extension function controlled by the actuation processing and control module 162.

The vehicle management system 158 connects to the hydraulic power supply & control system 154 via a signal connection 164 for receiving the system monitoring parameters. The actuation processing and control module 162 provides control of the arms 12 retraction and extension process which coordinates the control of the linear actuator 56 and the rotor 16 positions. The vehicle management system 158 connects to the actuation processing and control module 162 via a control signal 166 and also receives system monitoring parameters via a system monitoring signal 168. The actuation processing and control module 162 connects via a control data signal 170 to the hydraulic power and control system 154. A rotary position transducer 172 is connected to the idler arm 52 and the idler attachment bracket 54 for determining the position of the idler arm 52. Knowing the position of the idler arm 52 will ensure the coordinated retraction/extension of the arms 12 during forward flight or VTOL mode respectively.

The rotary position transducer 172 is connected to the actuation processing and control module 162 via a signal connection 174 so that the rotary position transducer 172 can provide position data of the idler arm 52 to the actuation processing and control module 162.

Each of the electric motors 14 can be controlled by a field-oriented control module 176. Each of the field-oriented control modules 176 connects via a bi-directional control data link 178 to the actuation processing and control module 162. The bi-directional control data link allows commands and feedback parameters to be shared between the field-oriented control module 176 and the actuation processing and control module 162, for the position control of the electric motors 14 and the rotors 16.

Each field-oriented control module 176 provides power to its associated electric motor 14 that it is controlling. The power is preferably provided via flexible electrical wires 180. The field-oriented control modules 176 receive position feedback from the hall-effect position sensor 152 via a position feedback signal 182.

When the aerial vehicle 10 is commanded via the vehicle management system 158 to the autopilot 160 via a communication signal 184 to operate in VTOL mode, then the autopilot 160 will command the field-oriented control modules 176 via a communications signal 186 (e.g. a bi-directional signal arrangement) to control the electric motors 14.

At any point in time, the vehicle management system 158 can command only the autopilot 160 or the actuation processing and control module 162 to provide command signals to the field-oriented control module 176, preventing both the autopilot 160 and the actuation processing and control module 162 from concurrently providing command signals to the field-oriented control module 176.

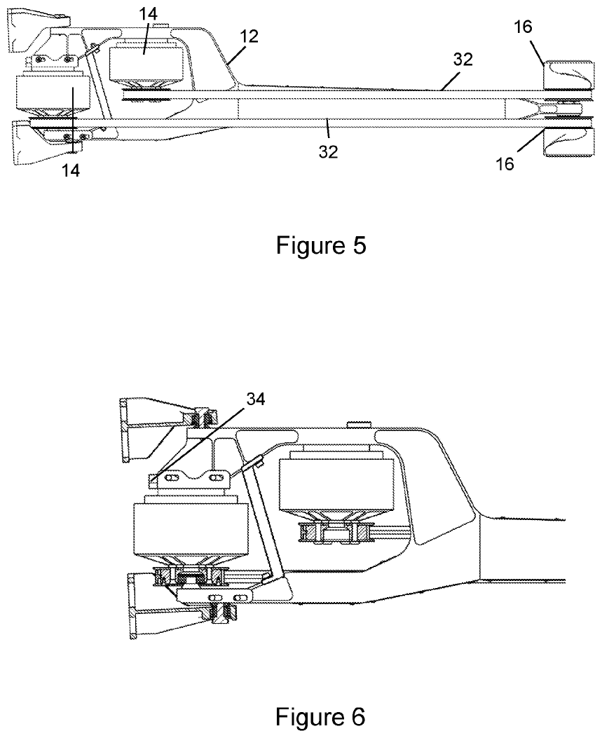

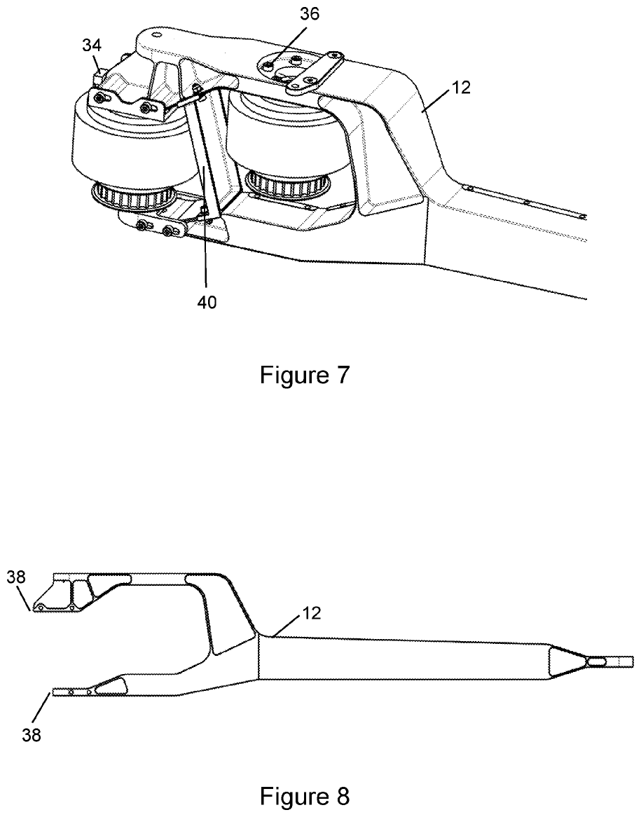

FIGS. 3 and 4 show the aerial vehicle 10 flying in arm 12 retraction mode from above (FIG. 3) and below (FIG. 4).

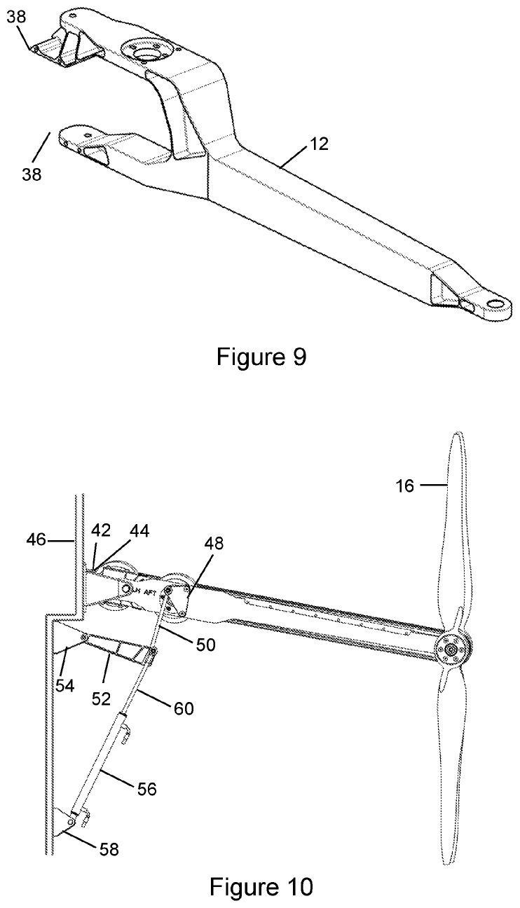

FIG. 5 shows the construction of the arm 12 with the rotors 16. In this embodiment, the electric motors 14 are not stacked, instead being offset from each other to reduce the overall profile of the aerial vehicle 10. The rotors 16 are attached to a shaft (not shown) with a propeller hub assembly 30, having rolling element bearings (not shown) and a drive pulley (not shown) fastened to each rotor 16.

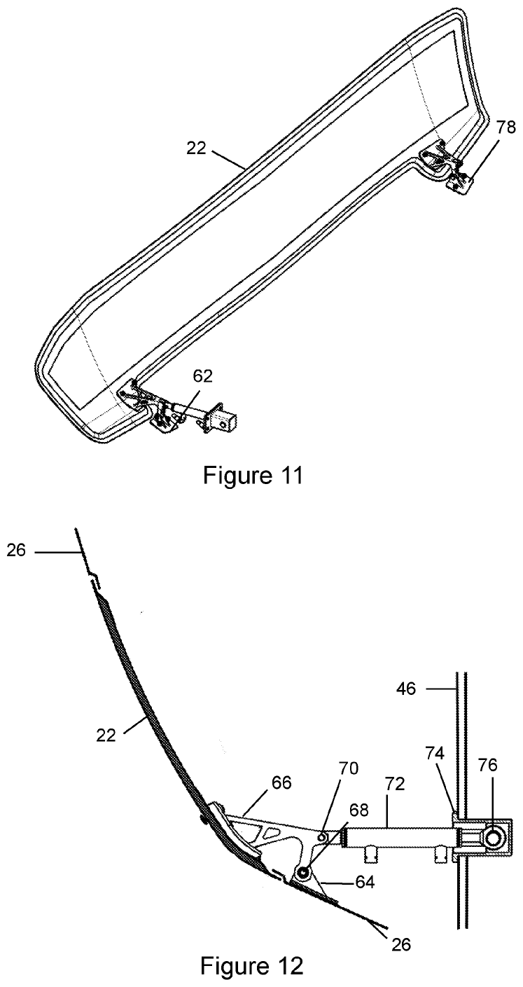

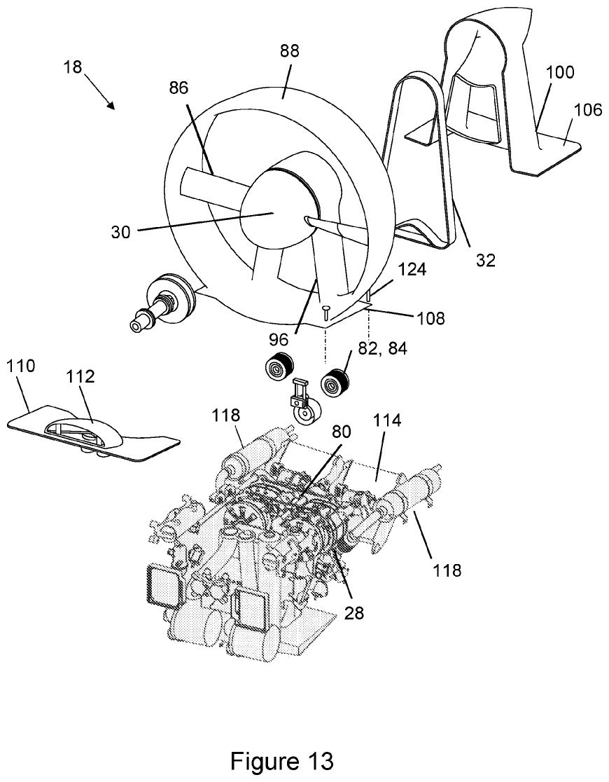

Each rotor 16 is driven by one of the electric motors 14 mounted at the opposite end of the arm 12 to the rotor 16 and being driven by a belt 32. Each electric motor 14 can be either attached to a mounting plate 34 as shown in FIG. 6, or the electric motor 14 can be attached directly to attachment holes 36 in the arm 12, as shown in FIG. 7. By attaching the electric motor 14 to the mounting plate 34, slotted holes (not shown) attach the mounting plate 34 to the arm 12 so that the electric motor 14 can translate and be adjusted to provide the required belt 32 tension.

In the event the electric motor 14 is attached directly to the slotted holes 36 in the arm 12, this also allows the electric motor 14 to translate and be adjusted to provide the required tension on the belt 32.

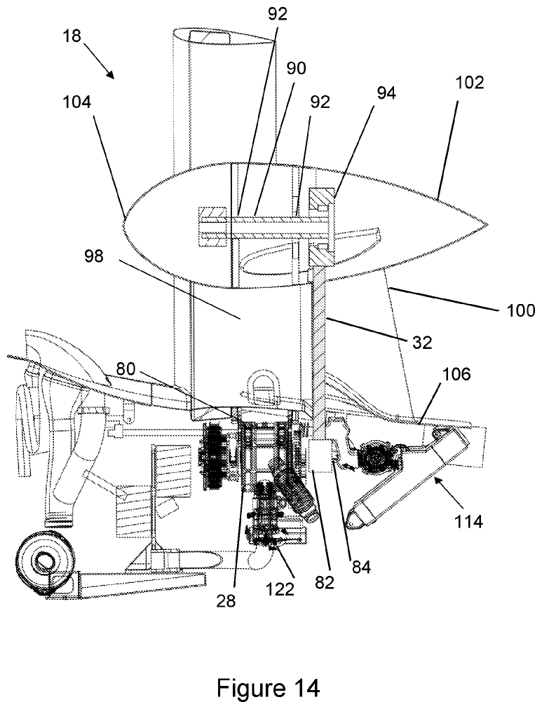

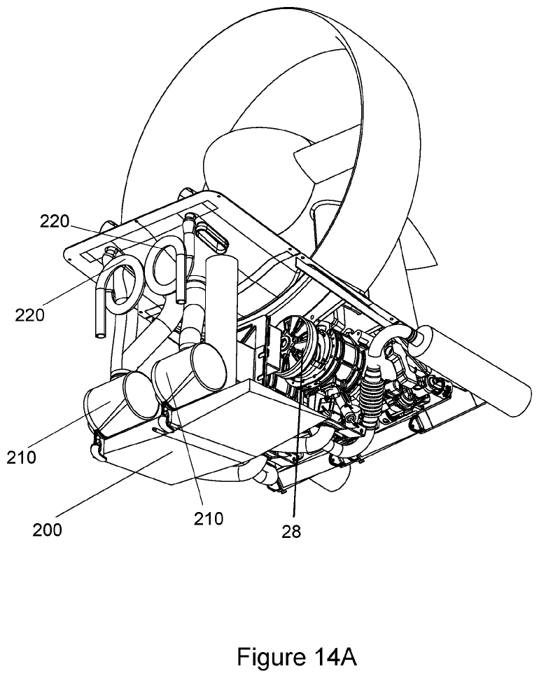

FIGS. 8 and 9 show the bifurcation of the ends 38 of arm 12 at the hinge end, to allow easy installation and removal of the electric motors 14 and adjustment of belt 32. A removable strut 40 shown in FIG. 7, can be installed between the bifurcated ends 38 and the arm 12 to provide additional structural rigidity.

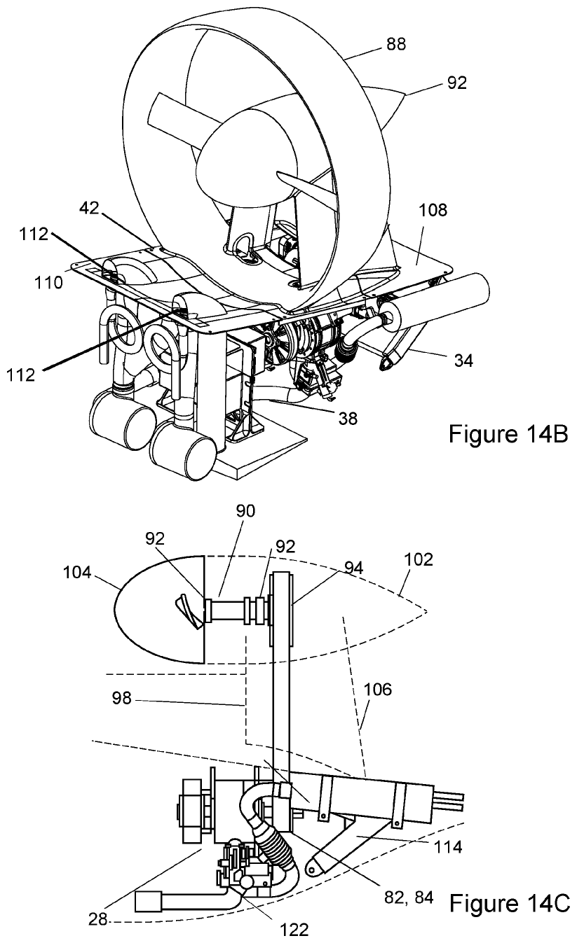

FIG. 10 illustrates the attachment of the upper attachment bracket 42 and lower attachment bracket 44 for each arm 12 to the internal structural frame 46 in the fuselage 26 using any appropriate mechanical fastener or adhesive. An actuation drive lug 48 is rigidly attached to each arm 12 allowing a pushrod 50 to be mechanically connected in a manner that allows the pushrod 50 to rotate relative to the actuation drive lug 48.

Referring to FIG. 10 continued, an idler arm 52 connects to the other end of the pushrod 50 in a manner that allows the pushrod 50 to rotate relative to the idler arm 52. The other end of the idler arm 52 connects to an idler attachment bracket 54 so as to constrain movement to be about a substantially vertical pivot axis. The idler attachment bracket 54 is attached to the internal structural frame 46 in the fuselage 26 by a mechanical fastener or adhesive. A linear actuator 56 is attached to the idler arm 52 in the vicinity of the pushrod 50 that is attached to the idler arm 52 in a manner that allows the linear actuator 56 to rotate relative to the idler arm 52. This allows the retraction or extension of the arm 12 when in forward flight mode. An actuator attachment bracket 58 is attached to the internal structural frame 46 using a mechanical fastener or adhesive.

The linear actuator 56 is attached to the actuator attachment bracket 58 in a manner that constrains motion about a substantially vertical axis and allows the linear actuator 56 to rotate relative to the actuator attachment bracket 58. The linear actuator 56 may be powered by an electric motor, hydraulic pressure or pneumatic pressure. In order to determine the position instantaneously of the actuator rod 60, the linear actuator 56 may have an integrated position sensor (not shown). This allows the coordination of movement of the arms 12 during retraction and extension.

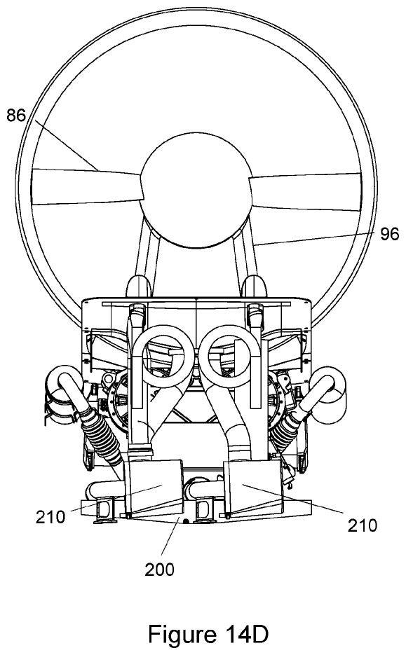

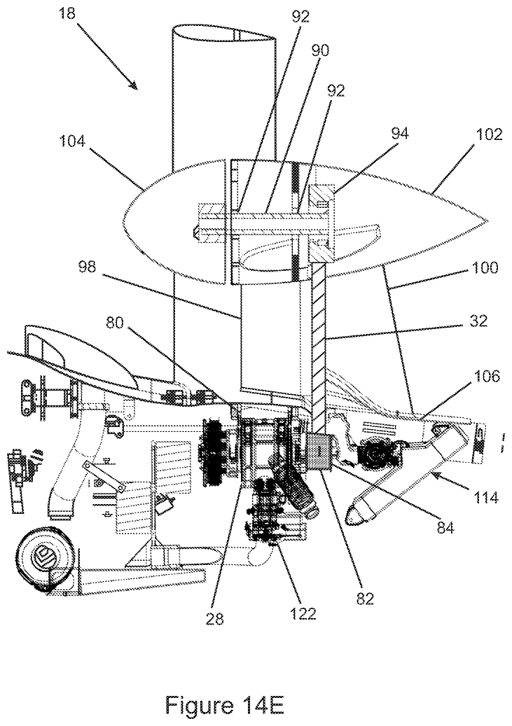

Referring to FIG. 11, the doors 22 for storing the arms 12 when retracted, are attached to the fuselage 26 with at least two hinge assemblies. At least one of the hinge assemblies is an actuator hinge assembly 62 comprising a fuselage attachment lug 64 and a door actuation lug 66, referring to FIG. 12.

The fuselage attachment lug 64 is mechanically fastened or bonded to the fuselage 26 and the door actuation lug 66 is mechanically fastened or bonded to the door 22. A door hinge pin 68 attaches the lugs 64, 66 to provide a door hinge rotation point.

The door actuation lug 66 has a door attachment point 70 for a door linear actuator 72 such that the door linear actuator 72 can rotate relative to the door actuation lug 66. The door linear actuator 72 is attached to a mounting bracket 74 with a pin 76 allowing the door linear actuator 72 to rotate relative to the mounting bracket 74. The mounting bracket 74 is attached to the internal structural frame 46 with mechanical fasteners. Referring to FIG. 11, one or more of the hinge assemblies may be a non-actuator hinge assembly 78 which has no provision for attachment of a linear actuator.

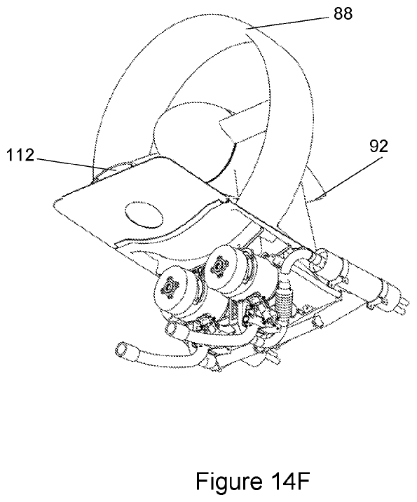

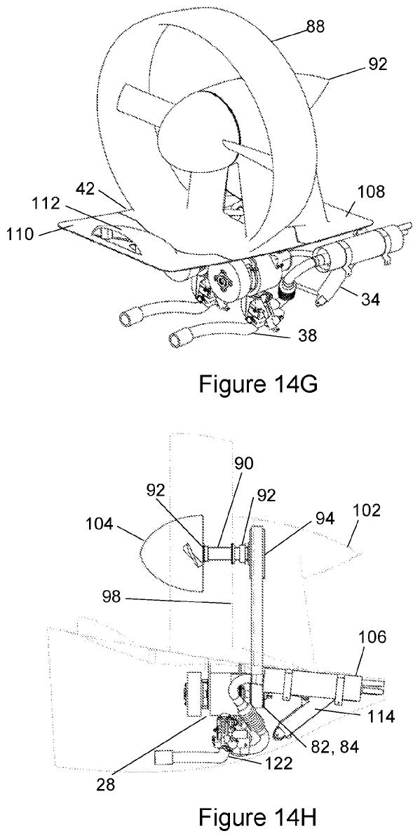

Referring to FIGS. 13, 14, 14A-14D in which the embodiment of the forward propulsion being provided by a fan 18 is illustrated along with its operation and components, and FIGS. 14E-14I which illustrate an embodiment in which the air intake 112 is a single intake, in comparison to the embodiment of FIGS. 14, 14A-14D, in which there is more than one air intake 112. In the embodiment of the fan 18 providing the propulsion, then the fan 18 will have a propeller 86 and a duct 88. The fan engine 28 can be one engine or multiple engines. The fan engine 28 is mounted to an engine frame 80, which is rigid. The mounting of the fan 18 is via a strut assembly 96 that protrudes into the airstream.

For the embodiment of the fan 18 being located above the fan engines 28, the strut assembly 96 will have two separate arms in an inverted CV′ shape as shown in FIG. 13. Each arm of the strut assembly 96 has two parts, a fixed structural part 98 and a removable aerodynamic strut fairing 100.

The removable strut fairing 100 allows the belt 32 to be installed and/or replaced as the belt 32 runs between the fixed structural part 98 of the strut assembly 96, and the removable strut fairing 100.

The fixed structural part 98 also provides a rigid point for the fan engine(s) to be attached to. The propeller hub assembly 30 also includes a fairing on the fan hub 102 and the fan nose 104, both aerodynamically suited to being in the airstream.

The removable strut fairing 100 can also include a removable part of the fan hub fairing 102.

Depending on the embodiment being used, a removable aft fairing cover 106 can form part of the removable strut fairing 100, or the removable aft fairing cover 106 can be separate from the removable strut fairing 100 or it may not even be present.

In the embodiment that the propulsion is provided by a fan 18, then an attachment cover 108 will be rigidly attached to the fixed structural part 98 of the strut 96, the engine frame 80 and the duct 88 (if fitted).

Additionally, there is a removable forward fairing cover 110 which can include one or more air inlets 112 for engine cooling and provide induction air to the fan engine(s) 28.

The removable forward fairing cover 110 and the removable aft fairing cover 106 when removed, will provide access to enable disconnection of the engine coolant system 114, the engine control electrical wiring 116, the engine exhaust system 118, the fuel supply hoses 120, the engine induction system 122, and any other services or systems being used. The entire fan engine 28 assembly is fastened to the fuselage 26 by fasteners 124.

A belt 32 connects the fan engine(s) 28 to the fan 18. The belt 32 may be one or multiple parallel belts and preferably a serpentine drive belt.

An idler pulley (not shown) is optional for tensioning of the belt 32 if required.

The fan 18 has a fan shaft 90 with bearings 92 and a shaft drive pulley 94, as per a standard fan setup.

Each of the fan engines 28 has a drive pulley 82 to connect the fan engine 28 to the belt 32.

In one embodiment, a clutch 84 is attached to each drive pulley 82 allowing the drive pulley 82 to be disconnected from the fan engine 28. In another embodiment, a separate belt 32 can be used for each fan engine 28 and the clutch 84 will then be in the hub 30 of the fan 18.

The clutch 84 can be a mechanical clutch whereby it completely disconnects the drive pulley 82 from the fan engine 28 when the clutch 84 is activated, or it can be a roller (or Sprag) type clutch that enables the drive pulley 82 to freely rotate when the fan engine 28 is not running (i.e. during VTOL), and to lock and drive when the fan engine 28 is operating and the shaft revolutions are sufficient enough for it to be driving.

The advantage of using a clutch 84 is that it allows the fan engines 28 to be operated at different power levels to each other, and additionally allows either fan engine 28 to be shut-down if not required.

This also implies that if one of the fan engines 28 fail, then the clutch 84 will allow the power to be delivered to the fan 18 from the remaining fan engine 28, allowing the aerial vehicle 10 to remain in forward flight.

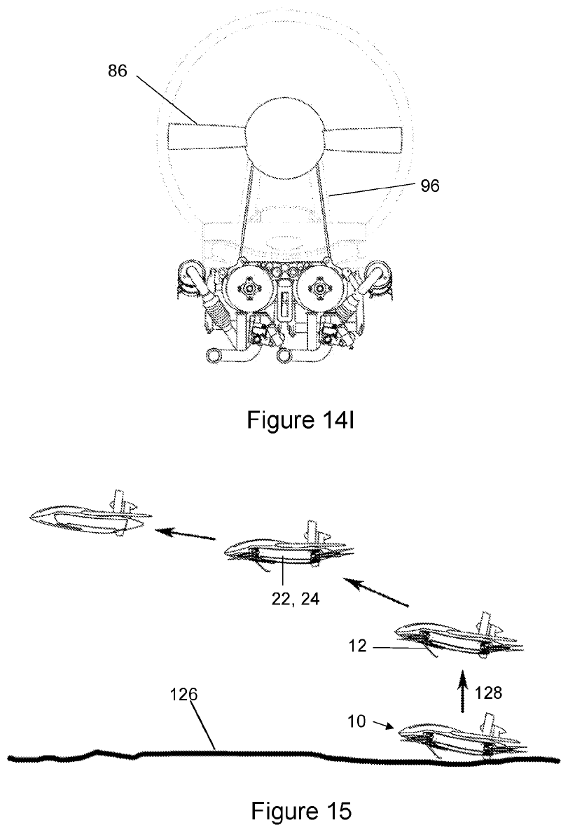

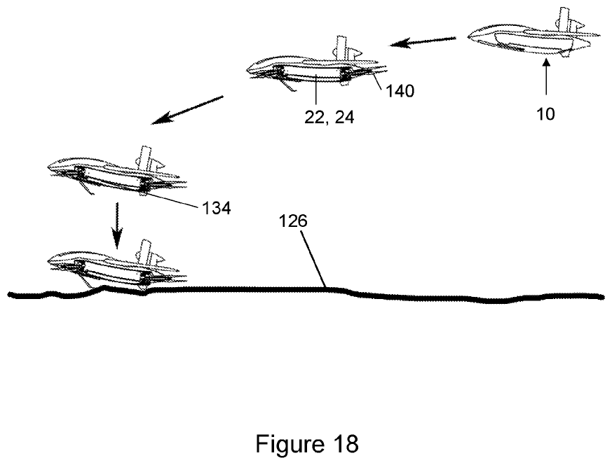

Referring to FIGS. 15 and 18, the method of flight of the aerial vehicle will be described. For take-off from the ground 126, the aerial vehicle 10 is in extension mode with all four pairs of arms 12 extended out and not stowed away in the openings 24 with the doors 22 open to enable the arms 12 to be extended.

The aerial vehicle 10 is then powered up by the electric motors 14 on the arms 12 to produce vertical lift. The aerial vehicle 10 then moves upward vertically as shown by arrow 128 in FIG. 15, to a safe minimum height required to clear any obstacles.

Once this minimum height has been achieved, the main propulsion system starts, that is, the fan engine 28 turns on and accelerates the aerial vehicle 10 to a minimum pre-determined flying speed. The aerial vehicle 10 is now in forward flight and the minimum pre-determined flying speed signals to the aerial vehicle 10 to retract the arms 12 and stow these within the openings 24, and subsequently, close the doors 22.

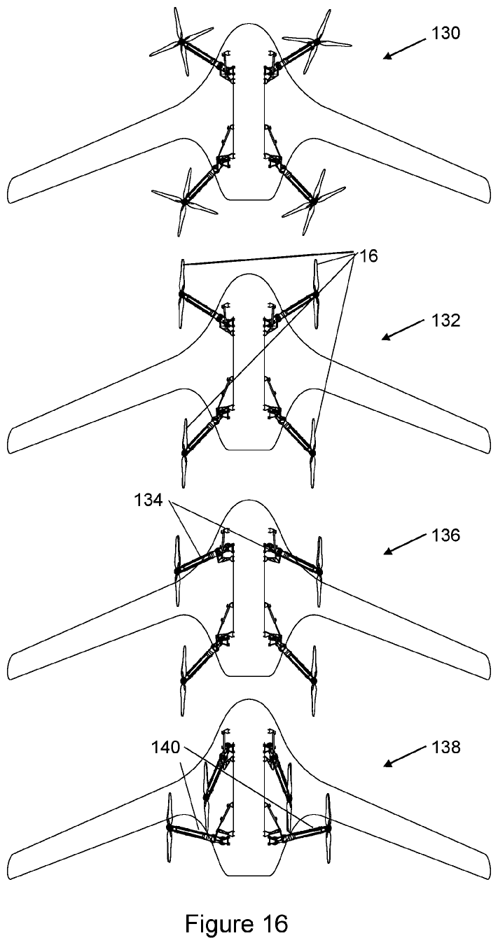

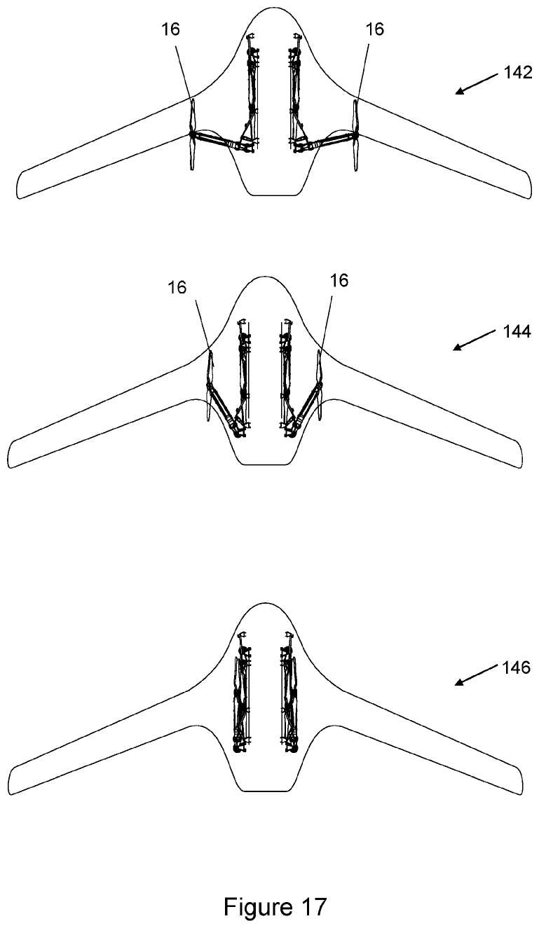

The way in which the arms 12 are retracted and stowed are shown in FIGS. 16 and 17. Upon initial take-off 130, the arms 12 are shown extended. On reaching the minimum pre-determined flying speed 132, all the propellers 16 stop and are aligned having their long axis substantially parallel to the airflow.

At 136, now that the vertical lift has stopped, and the forward thrust from the fan 18 has started, the arms 12 at the forward of the aerial vehicle 10 (i.e. the arm pair 134 on opposing sides of the aerial vehicle 10 at the forward region of the aerial vehicle 10) then move towards the rear of the aerial vehicle 10. The movement of the arm pair 12 is substantially at the same rate, where the propellers are kept aligned to the airflow direction during the movement.

At 138, the forward arm pair 134 have retracted and rotated sufficiently to allow the rear arm pair 140 to commence rotation and retraction into the opening 24 without interfering with the forward pair of arms 134, where the rear arm pair 140 move towards the forward region of the opening 24. Again, all the propellers 16 are kept aligned with the airflow during the movement. At 142, and 144, the forward arms pair 134 have reached the retracted position, and the rear arm pair 140 are still moving to their retracted position.

At 146, the rear arm pair 140 have retracted substantially parallel to the forward arm pair 134 in the openings 24. At this point, the doors 22 are then able to be closed, and the aerial vehicle 10 is flying in forward flight.

Referring to FIG. 18, the landing of the aerial vehicle 10 is shown. The reverse of the method outlined in regard to take-off and forward flying, is performed in order to land the aerial vehicle 10. That is, the doors 22 open, the rear pair of arms 140 extend first from the openings 24, substantially at the same time, from the front region towards the rear of the aerial vehicle 10. Once these are far enough extended, the forward pair of arms 134 extend from the openings 24 extending out from the rear of the openings 24 towards the front region of the aerial vehicle 10. Then the fan engine 28 is turned off, whilst the electric motors 14 are turned on, reducing the speed of the aerial vehicle 10 to the minimum flying speed, and bringing the aerial vehicle 10 to a hover. The aerial vehicle 10 is then decelerated, and begins its vertical descent reliant solely on the propellers 16 of the arms 12. Once the aerial vehicle 10 reaches and touches the ground 126, the aerial vehicle has its electric motors 14 powering the propellers 16 turned off.

It will be appreciated that whilst the following particular embodiments are described with reference in places to earth conditioning apparatus, the present invention finds application with other ground/earth engaging apparatus.

It is to be understood that, if any prior art is referred to herein, such reference does not constitute an admission that the prior art forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An aerial vehicle comprising:
a fuselage and at least one wing;
a propulsion system for forward flight of the aerial vehicle;
at least two pairs of arms, each arm supporting at least one rotor, wherein each rotor is powered for vertical take-off and landing (VTOL) of the aerial vehicle; and
wherein each arm is retractable between a deployed position for vertical take-off or hovering and a retracted position during forward flight.

2. An aerial vehicle of claim 1,
wherein each arm is deployable between the retracted position during forward flight and the deployed position for hovering and/or vertical landing;
wherein the at least one wing and the fuselage comprise a blended-wing structure or blended wing body (BWB) structure;
wherein the aerial vehicle includes at least one recess for receiving at least one of the arms when retracted;
wherein the aerial vehicle further comprises at least one door to cover the at least one recess and/or respective arm when received within the at least one recess; and/or
wherein the arms on a first side of the aerial vehicle are retractable into a first recess, and the arms on a second side of the vehicle are retractable into a second recess.

3. An aerial vehicle of claim 2, wherein:
the at least two pairs of arms comprise a front left arm, a front right arm, a rear left arm, and a rear right arm;
wherein the front left arm and rear left arm are configured to retract into the first recess and/or the front right arm and rear right arm are configured to retract into the second recess; and
wherein at least two pairs of arms comprise a front pair and a rear pair, where the front pair comprises the left and right front arms, and the rear pair comprises the left and right rear arms.

4. An aerial vehicle of claim 1, wherein:
each pair of arms is configured to move at a different rate and different rotational rate to the other pair of arms when extending or retracting:
the rotors are aligned to a longitudinal axis of the aerial vehicle during at least part of the retraction and/or deployment of the arms;
the alignment of the rotors is by use of at least one position sensor;
the at least one position sensor includes at least one rotary sensor for detecting rotational position of the respective rotor and/or an associated motor and/or associated drive belt; and/or
a respective rotor is stopped when a respective at least one position sensor senses a long axis of the respective rotor is substantially parallel to a longitudinal axis of the aerial vehicle during retraction and/or deployment of the arms.

5. An aerial vehicle of claim 3, wherein:
the front and rear pairs of arms are configured to move in synchronisation when being extended or retracted;
each pair of arms moves through symmetric ranges of motion at substantially the same velocity; and/or
the front and rear arms within each pair move during extension and retraction through identical symmetric ranges of motion at substantially the same velocity.

6. An aerial vehicle of claim 1, wherein:
the propulsion system includes at least two power units;
each of the power units is the same as the other of the power units or the power units differ in capability or type from each other;
the power units include at least one of a rotary internal combustion engine, a gas turbine engine or an electric engine; and/or
the propulsion system includes at least one fan powered by the at least two power units.

7. An aerial vehicle of claim 2,
further comprising an air speed and/or power unit speed configured to provide a signal to open each door and stow each pair of arms into each recess/opening, and/or extend each pair of arms from each opening;
wherein the signal is provided by a position sensor indicating a position of one or more electric motors and/or the rotors; and/or
wherein the position sensor includes a combination of a dipole magnet and a hall effect position sensor.

8. An aerial vehicle of claim 1,
further comprising at least one electric motor configured to power a respective rotor, and wherein the at least one electric motor is located on a respective arm;
wherein a position of the electric motor(s) is adjustable;
wherein a tension of a belt to convey drive from the at least one motor to the respective rotor is configured to be adjustable;
wherein the at least one electric motor is attached to a mounting plate mounting to at least one of the arms;
wherein the mounting plate has holes for position and tension of the driving belt to be adjusted; and/or
wherein the at least one rotor includes two contra-rotating rotors.

9. An aerial vehicle of claim 1, wherein a fuselage end of at least one of the arms is bifurcated to provide space for at least two motors to be installed and respective driving belts adjusted.

10. An aerial vehicle of claim 1, wherein:
a linear actuator is configured to deploy and/or retract at least one arm; and
the linear actuator is powered by an electric motor, hydraulic pressure or pneumatic pressure.

11. An aerial vehicle of claim 10, wherein:
the linear actuator has a position sensor; and
the position sensor provides an instantaneous position of a rod of the linear actuator.

12. An aerial vehicle of claim 1, wherein:
the propulsion system is stowed away during take-off and landing;
the propulsion system is supported by a support arrangement;
the support arrangement includes at least two struts in an inverted CV′ configuration;
at least one battery is included onboard the aerial vehicle to power the vehicle during VTOL; and/or
during forward flight, when the aerial vehicle is not in VTOL mode, the at least one battery is in recharge mode recharging ready for when the aerial vehicle is placed in VTOL mode.

13. An aerial vehicle comprising: a propulsion system including at least two engines, wherein the at least two engines are arranged and configured to power at least one propulsion system.

14. An aerial vehicle of claim 13, wherein the at least two engines power the at least one propulsion system, thereby enabling forward flight of the aerial vehicle.

15. An aerial vehicle of claim 13, wherein:
the propulsion system includes at least one ducted fan, fan or propeller configured to be powered by the at least two engines via at least one belt; and
the at least one belt includes a single drive belt or multiple belts.

16. An aerial vehicle of claim 13, wherein the at least two engines is operatively coupled to at least one clutch or at least one said engine is operatively coupled to a respective clutch.

17. An aerial vehicle of claim 16, wherein the at least one clutch allows one of at least two drive pulleys to freewheel when one of the at least two engines is off.

18. An aerial vehicle of claim 16, wherein the at least one clutch includes a roller or Sprag type clutch.

19. A method of operating an aerial vehicle, said method comprising one or more of:
A) during forward flight of the aerial vehicle:
a) transitioning the aerial vehicle to a forward flight mode by retracting vertical lift rotor arms for full forward flight, or
b) transitioning the aerial vehicle to a vertical landing mode by extending the vertical lift rotor arms;
B) transitioning arms supporting lift rotors from an extended position to a retracted position, or between a retracted position and a deployed position, during forward flight of the aerial vehicle;
C) extending arms supporting lift rotors for vertical take-off;
ascending the aerial vehicle and generating forward flight; and
retracting the arms and rotors; and
D) during forward flight, extending arms supporting lift rotors to an extended position;
reducing forward flight propulsion and increasing lift from the lift rotors; and
descending the aerial vehicle to a landing position with the arms extended and the lift rotors providing descent power.

20. The method of claim 19, wherein each said rotor arm supports at least one rotor, and wherein the at least one rotor ceases rotating prior to or during retraction; wherein the retraction and extension of the arms is powered by pneumatic, hydraulic or electrical means; wherein the retraction of the respective arm or arms includes pivoting retraction and/or elongate retraction; wherein the extending comprises pivoting a deployment and/or elongate extension; wherein for retraction and/or stowage of the respective rotor(s) and/or arm(s), a rotational position of the respective rotor is sensed, and a desired rotational position maintained during retraction and/or deployment of the respective arm(s); and wherein the method further comprises:
position sensing of the respective rotor is by a sensor;
the sensor includes one or more of a rotary encoder, Hall effect sensor, optical sensor, magnetic sensor, or a combination of two or more thereof;
position sensing for each motor, wherein the position sensing for each motor comprises sensing rotor or stator position of the motor with respect to a reference; and/or
rotor position sensing.
